(19) United States
(12) Patent Application Publication
(10) Pub. No.: US 2011/0184769 A1
(43) Pub. Date: Jul. 28, 2011

(54) SYSTEM AND METHOD FOR PLANNING, SCHEDULING AND MANAGING ACTIVITIES

(76) Inventor: JANET LYNN TIBBERTS, Greenwich, CT (US)

(21) Appl. No.: 13/013,883

(22) Filed: Jan. 26, 2011

Related U.S. Application Data
(60) Provisional application No. 61/298,612, filed on Jan. 27, 2010.

(51) Int. Cl. G06Q 10/00

(52) U.S. Cl. 705/5

(57) ABSTRACT

The invention relates to computer based methods and systems for planning, managing and scheduling of the participation of users, be they individual or groups, in an exponential smoothing manner with respect to activities at, e.g., a mega amusement park (“MAP”) or other venue.

### RELATED APPLICATION

This application claims benefit from provisional application Ser. No. 61/298,612 filed Jan. 27, 2010, which his incorporated by reference in its entirety.

### FIELD OF THE INVENTION

The system and method described herein (referred to hereafter as the “System”) comprises a system and computer based methods for planning, scheduling and managing the participation of family units or sub-units in an exponential smoothing manner with respect to rides, shows and other events and guest activities at an amusement park, theme park or other attraction (referred to hereafter as a “MAP” or “mega amusement park”). The System permits users to access the System, for example, through a computer over the Internet or through a computer onsite at the MAP or at another location. The System permits the user to rank in order all the rides and other attractions that the user would like to use during a specific day, either alone or with others. In operation, the System processes the information and provides the user with a schedule of reservations for attractions (based upon the requests of the user and availability).

This computerized queuing method helps to exponentially smooth the guest activities in which group units and sub-units participate at a MAP. The information provided by the System permits the manager of the MAP to plan where to place employees of the MAP. The System directs users out of “bottle-neck” or congested areas during busy times and to less busy areas of the MAP where other activities are more readily available.

In one preferred embodiment of the invention, the System provides guest activity schedules which allocate and reserve a schedule of specified guest activities at a MAP for a user. The schedule is based upon input received from the user with respect to factors which include, among other things, age preferences and other relevant criteria using defaults specified with regard to those criteria, all using a computer network or an Internet based system.

### BACKGROUND AND PRIOR ART

Present systems for the scheduling of activities at, e.g., MAPs provide limited advance scheduling functions. “Fast passes” and “bypass the line” systems are known as prior art. In most cases, these are bought the same day as the visit to the MAP. Hence, there is no way for those systems to help the MAP owner or operator estimate the number of employees needed or food and products to have on hand. Due to the lack of advanced scheduling, management must instead rely upon previous years' attendance figures, weather forecasts, the economy, and so forth to plan. While one might rely on hotel reservations at surrounding hotels that the MAP owner or operator also owns, if the information were available, information from other surrounding hotels may not be available, so the information would be incomplete. As a consequence, MAP owners and operators do not have the flexibility to optimize the schedule of guest attractions.

One prior art method is a pass that is a place holder. It enables the ticket holder to take that ticket, place it in line, enjoy other activities, and then return at a time designated via the ticket. The ticket literally holds the guest's place in line, although only one line at a time. This does not work well for busy days and busy rides with longer waiting times. It is rather limiting for busy vacation weeks, for extremely popular rides, and for busy time periods.

Another approach to these issues is a computerized medium, such as, but not limited to a belt, buckle, pin, and so forth, offered by chains of amusement parks. The computer disk is linked directly to a main computer. The guest scrolls down the options until s/he finds a desired activity. The guest selects it and is informed what time the guest and the guest's party should be at the activity.

Yet another approach is the family type pass. The family type pass requires a family sub-unit to be together. The holder of the pass walks through a line and hands the family type pass to the employee. As soon as there is room available, the guest riders are given priority and put onto the ride or other attraction. On busier days there would be a longer wait.

As such, a need exists for a system and method that facilitates the managing of guest activities at MAPs that addresses the numerous problems with prior management systems.

### BRIEF DESCRIPTION OF THE FIGURES

FIG. 1 depicts one embodiment of the invention.

### DETAILED DESCRIPTION OF PREFERRED EMBODIMENTS

In one exemplary embodiment of the present invention, the System comprises five integral parts. First, there is the MAP hotel reservation computer used by the owner/operator. Second, there is the actual user device that may be activated, for example, by computer, at home, at a hotel or at the actual MAP. Third, there is the MAP processing system. This is a website that comprises a scheduling module, a processing module and a payment module. Fourth, there is a database that comprises a storage unit. Fifth, there is a network that links all the facets together. These five parts make up the System, which will be discussed in more depth below.

In use, the System is initiated with reservation and password generation. The hotel reservation system receives a guest user request by phone or computer to reserve calendar days in its hotel. The hotel reservation system then processes that request based upon availability and payment screens.

Next, the hotel reservation system receives a request to generate a password. The hotel reservation system either generates a password for the user or prompts the user to create one. Either approach is accomplished via methods well known to the skilled artisan, which need not be repeated here.

Next, the reservation system generates the password, which is sent to the user. The hotel reservation system then stores the password in a database associated with the reservation file. The hotel system also requests the user to supply the group unit names and ages, plus the relevant dates of attendance at the MAP, and stores that information.

Next, the System schedules rides for the user. The System displays a web page, which includes a sign-in page. The user signs into the system by using a computer or other device. The System receives the guest user's request to login and processes the request. Once the login is verified, the web page system displays the requested fields. The first part of the scheduling system displays available rides and also available time slots in specified time increments, for example 30 minutes.

The user either receives group unit and group sub-unit information from the hotel reservation computer or inputs the various group members and ages by sub-unit. The user will select each ride or other activity to fill the time slots by group or group sub-unit.

The second part of the System, the processing module, then performs a number of steps. It first processes the request. It then presents and describes the rules for scheduling. After that, it describes the MAP zones (zones or areas on the map of the MAP). The System assures the user is not jumping from zone to zone in each time slot. For example, the System confirms that groups with young children will not be riding rides in different zones with each time slot.

In the following step, the System displays the user's schedule of rides and other attractions that have availability. It also displays problems, such as over-scheduling, and makes suggestions to correct the problems.

Next, the System requests and accepts adjustments to the schedule from the user. The System then processes the adjusted schedule and displays the adjusted schedule for the user.

The third part of the System, the payment module, prompts the user to accept the schedule. If accepted, the System displays the a payment request to the user and requests input of the necessary payment information. After receiving the payment information, the System processes and stores the payment information in its database.

After the System has stored the schedule and payment information for the user, it mails or e-mails a confirmation (with confirmation number or identifier) to the use. It also mails any tickets to the user or holds the tickets, e.g., at the user's hotel or at the MAP ticket window.

After all of the above steps have been carried out and the schedule for a user has been finalized, the System sends the information to all of the parts of the system described here. The MAP network supplies the aggregate of all the user schedules processed by the network to the MAP owner or operator, giving the MAP owner or operator information on how many users will be in the MAP that day and what attractions they will be attending. This information assists MAP management in determining, for example, where to locate its employees, on a given day, also helps restaurants and shops to better estimate what products to stock and how much they need on hand on a particular day.

The fourth component of the invention is the database. This is a storage unit that holds all the various pieces of information discussed above, including, for example, the availability of the places on the rides and attractions, the confirmed schedules and the employees' information and availability.

The final component of the system is the network, which links all of the other system parts together. It links the various modules together with the reservation computer and the database and also links the user's computer or other device to all the system parts, all for the purpose of facilitating the MAP's resources and demands.

The system methods parts of the invention comprises of the reservation and password generation system and the scheduling system. Both are essential to make the system methods complete.

The reservation and password generation system uses four steps. The first step is the receipt of the user's request to reserve calendar days at the hotel. The request contains the guest and family names, ages, and dates of stay. That request is then processed. Then, the system prompts the user to request a password to enable the user to access the System, or in another embodiment, generates one automatically. After the password is inputted, the reservation and password generation system verifies that the user qualifies for the use of the System. If that user does qualify, then the reservation and password generation system generates a password for the user name assigned to the user. The reservation and password generation system stores the password in the database that is associated with the hotel and other information of the user. The reservation and password generation system then enable the System to operate for the user.

The next feature of the System is the scheduling of rides and attractions at the MAP using the scheduling system. The reservation and password generation system has generated a user password and the user may review the MAP web page. The System, in response to the user's request, displays a web page that includes a login page for the password. The user inputs the password and user name. The System receives the request from the user to login and to begin the verification process.

In this process, the System verifies the information and, if the information matches the user name and associated password on its database, allows the guest user to proceed. Next, the System requests the user to verify the user's information, including the user's groups names and ages, plus what days the user's groups will be visiting the MAP. Once the verification process is completed, the System displays the requested fields with the available rides and other attractions.

The next step in scheduling involves the System receiving the user information. This step requires the System to receive the guest user's various group member names and ages, arranged into one unit or more sub-units. The System requests the user to arrange the various rides and other attractions from a menu into various time slots, such as 30 minutes. The System prompts the user to do this for each sub-unit.

Next, the System processes the request. If there are any constraints on the request, the System displays these to the user. As an example, “this family member is age 6 and this ride is for ages 8 and up” may display if appropriate.

The System also displays any warnings to the user. Each part of the MAP is separated into a zone, listed by a letter, color, or other designation. For example, if the user were to request rides every 30 minutes in zones far from each other, the System would provide a warning, such as, “Your group has children under age 8. You have jumped more than two zones in one hour. This is not recommended.”

After the System has processed the request, the System displays the schedule to the user. This schedule includes the users requested schedule, plus times that the System had found available for the requested rides and other attractions. The System also displays problems with the schedule to the user and make suggestions, such as, “This ride is in the same zone, but has seats available.” The System also displays any zone warnings, as described above.

The System helps to prevent bottlenecks in high traffic areas of the MAP. The System does this, for example, by limiting the number of guests on a ride, and also limiting the number of guests in a bottleneck area. For example, instead of having thousands of guests trying to get over a bridge in one zone after lunch, the System moves the guests to another zone that has more space.

The user then makes the necessary changes and adjustments. The System receives the adjustments from the user and then processes the adjusted schedule by going through the process of verifying ride availability plus any age constraints (including the zone warnings), all of which were explained above.

The System then displays the adjusted ride schedule to the user. The user then reviews the ride schedule. The user either makes additional changes or accepts the proposed schedule.

The System receives the user's acceptance and displays a payment request to the user. The user inputs the payment information, and the System receives it. If payment is required, the System processes the user's payment information, including verifying any credit card information and charging the credit card. If payment is required, only after the System has received the payment, would the schedule of the user actually be reserved.

The System stores the information and mails or e-mails to the user the finalized schedule along with a confirmation number. The System also sends out the actual tickets to the MAP.

The last step has the System send the information to the database for storage. Once in storage, the various parts of the System access the information. In this way management has a better idea, for example, as how many employees to have working that day and how much food and other merchandise to have available on hand.

One additional embodiment of the invention is to permit ticket or schedule reissue points anywhere MAP guest services has an office. Guests may lose their schedules and/or need schedules reissued or revised. A possible safety feature may be added, for example, if the guest only loses the schedule or the ticket, one of those would not be usable without the other.

The presently disclosed system and method can be implemented using hardware, software or a combination of hardware and software. In particular, the disclosed system and method can be implemented using a computer system with a single personal computer or a network of multiple computers in local area networks, wide area networks, intranets or the Internet. The disclosed system and method can be implemented using either object-oriented programming languages, such as JAVA™ and C++ programming languages, or procedural programming languages such as C programming language. Preferably, the disclosed system and method are implemented as a JAVA-based application accessible by multiple end user computers on a website available over the Internet.

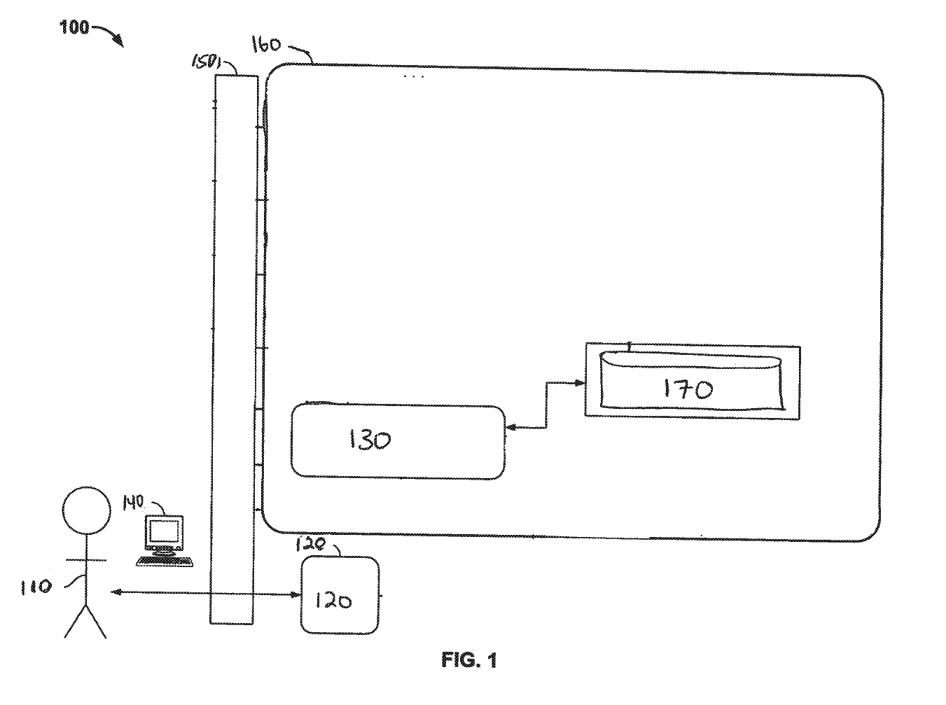

Referring now to FIG. 1, there is shown a typical network configuration 100 in which the invention may operate, and a block diagram showing the major modules of the invention. In alternate embodiments, however, various other types of electronic devices communicating in a network may also be used and various other modules may be included as would be well understood by those of skill in the art. A User 110 communicates with a computing environment, which may include a Web Server 120 or multiple server computers in a client/server relationship on a network communication medium such as the Internet 150. In a typical client/server environment, Web Server 120 includes a Web Application 130 that communicates with a User Device 140, which may be a personal computer (PC), a hand-held electronic device (such as a PDA), a mobile or cellular wireless phone, a TV set, or any other web-enabled electronic device as would be understood by those of skill in the art.

The Server 120 and the User Device 140 may each have any conventional general purpose single- or multi-chip microprocessor. In addition, the microprocessor may be any conventional special purpose microprocessor such as a digital signal processor or a graphics processor. Additionally, the Server 120 and the User Device 140 may be a desktop, server, portable, hand-held, set-top, or other type of computing devices. Furthermore, the Server 120, and the User Device 140 each may be implemented in connection with any operating system.

The Server 120 and the User Device 140 may each include a network terminal equipped with a display, keyboard and pointing device. In an exemplary embodiment of the Network 100, the User Device 140 includes a web browser used to access the Server 120. The User 110 through the User Device 140 may utilize the browser to remotely access a website hosted by Server 120 using a keyboard and/or pointing device and a display, such as a monitor. Although FIG. 1 shows only one User Device 140, the Network 100 may include any number of User Devices.

The Network 100 may be any type of electronic transmission medium including but not limited to, a virtual private network, a public internet, a private internet, a secure internet, a private network, a public network, a value-added network, an intranet, or a wireless gateway. The term “virtual private network” refers to a secure and encrypted communications link between nodes on the network 100, a Wide Area Network (WAN), Intranet, the Internet 150 or any other network transmission means. In addition, the connectivity to the Network 100 may be via, for example, Ethernet, Token Ring, Fiber Distributed Datalink Interface, Asynchronous Transfer Mode, Wireless Application Protocol, or any other form of network connectivity. The User Device 140 may connect to the Network 100 by use of a modem or by use of a network interface card that resides in the User Device 140.

FIG. 1 also includes an Application Facility 160, which includes various software modules for retrieving, updating and displaying data requested by User 110 as contemplated by the present invention. Although the term “facility” is used, components do not necessarily need to be at a common location. Application Facility 160 also comprises Database 170 which stores all necessary information for properly executing the processes of the present invention

As will be well known to those of skill in the art, devices other than the hardware configurations described above may be used to communicate with Server 120.

The above description presents method steps that may be implemented using processor-executable instructions, for directing operation of a device or devices under processor control. The processor-executable instructions may be stored on a computer-readable medium, such as a CD, DVD, flash memory, or the like. The processor-executable instructions may also be stored as a set of downloadable processor-executable instructions, for example or downloading and installation from an Internet location (e.g Web server).

Although the present invention has been described in considerable detail with reference to certain versions thereof, other versions are possible. For example, said invention could be implemented in a variety of settings where crowd control and management is desirable, such as fairs, festivals, and the like. Any and all such versions and others as readily understood by those of skill in the art are contemplated by the present invention.

1. A method for optimizing participation of an individual at a venue, comprising:
(i) providing an individual with access to a reservation system for securing a reservation at said venue;
(ii) providing said individual with access means for accessing information from said reservation system;
(iii) providing said individual with access to options for participation at said venue;
(iv) processing any selections made by said individual after (iii);
(v) providing said individual with a schedule based on said selections, together with information on corrections, if necessary;
(vi) requesting payment information following acceptance of said schedule; and,
(vii) storing information provided in steps (i) through (vi).

2. The method of claim 1, comprising providing said access in (i) via a web page.

3. The method of claim 1, wherein said access means is a password.

4. The method of claim 1, comprising providing access in (iii) via a second web page.

5. The method of claim 1, wherein said venue is a mega amusement park.

6. The method of claim 1, wherein said reservation system is a reservation system for a hotel associated with said venue.

7. The method of claim 5, wherein said options in (iii) comprise rides, shows, and restaurants.

8. The method of claim 7, wherein said options further comprise time intervals for attendance.

9. The method of claim 1, further comprising requesting information from said individual regarding attendees after step (ii) but before step (iii).

10. The method of claim 1, wherein (v) comprises information regarding unsuitability or unavailability of said options, based upon information provided by said individual.

11. The method of claim 1, further comprising forwarding information stored in (vi) to an operator of said venue.

12. The method of claim 1, further comprising transmitting conformation of attendance at said venue to said individual.

13. The method of claim 1, further comprising transmitting attendance tickets for said venue to said individual.
